(19) United States
(12) Patent Application Publication
(10) Pub. No.: US 2007/0204118 A1
(43) Pub. Date: Aug. 30, 2007

(54) System and method of managing the memory content of a device

(75) Inventor: Scott White, Austin, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures ,L.P.

(21) Appl. No.: 11/365,296

(22) Filed: Feb. 28, 2006

(51) Int. Cl. G06F 13/00

(52) U.S. Cl. 711/159; 711/154

(57) ABSTRACT

A method of managing the content of a digital video recorder (DVR) is disclosed. The method includes receiving digital content and accessing a memory device used for storing digital content. The received digital content is compared with previously stored digital content stored in the memory device. Based on the comparison, a determination is made if the received digital content has previously been stored in the memory device. The received digital content is then selectively stored within the memory device, based on the determination.

### FIELD OF THE DISCLOSURE

The present disclosure relates to managing the memory content of a device, for example a digital video recorder (DVR).

### BACKGROUND

For years, televisions have been a staple of consumer electronics sales. As such, a large majority of households in the United States owns at least one television. Providing content to those televisions is a lucrative business and there are numerous types of television content to choose from. For example, viewers can subscribe to digital broadband television networks and digital satellite television networks in order to receive standard digital television content or high definition television content.

Digital video recorders (DVRs) are used by many viewers to record programs broadcast at times when they are not available or are viewing another program.

These DVRs can be set to record all episodes of a given program.

However, television networks may broadcast the same episode of a given program multiple times within a relatively short period. This is especially true of children's programming or heavily syndicated shows.

This complicates the experience of DVR users who may wind up with redundant copies of the same program on their DVR. The user then has to spend time manually deleting redundant shows.

Also, potentially desirable content may be auto-deleted by the DVR to make room for redundant shows, meaning less diversity in the user's library of DVR recordings. This issue is especially pronounced in DVRs with limited hard drive space.

Some DVRs attempt to rectify this problem by deleting programs based on a text metadata comparison. The DVR would use text metadata supplied in conjunction with the program or separately via an Electronic Program Guide (EPG) feed to compare, for example, episode descriptions. If the episode description matches one already recorded, the redundant show is either deleted or not recorded in the first place.

One problem with this method is that many shows utilize generic program descriptions. Because of this, deleting shows based on comparing program text data will often result in deletion of non-redundant episodes.

### BRIEF DESCRIPTION OF THE DRAWINGS

The present disclosure is pointed out with particularity in the appended claims. However, other features are described in the following detailed description in conjunction with the accompanying drawings in which:

FIG. 1 is a block diagram representative of an entertainment system;

FIG. 2 is a flow chart to illustrate general operating logic that can be used to manage the memory content of a DVR;

FIG. 3 is an example of waveform data from a recording and a potential duplicate recording being compared;

FIG. 4 is an example of waveform data from a recording and a matching duplicate recording being compared; and

FIG. 5 is an example of waveform data from a recording and a matching duplicate recording being compared by moving the recordings in time to match the peaks and valleys.

FIG. 6 is a block diagram illustrating an example embodiment of an Internet Protocol Television (IPTV) system that may be used to provide video content is illustrated and in conjunction with which the above described technology may be deployed.

FIG. 7 shows a diagrammatic representation of machine in the example form of a computer system within which a set of instructions, for causing the machine to perform any one or more of the methodologies discussed herein, may be executed.

### DETAILED DESCRIPTION OF THE DRAWINGS

A method of managing the memory content of a device, in one example a DVR, is disclosed and includes receiving data relating to a digital program and accessing a memory device used for storing digital programs. The method also includes comparing a portion of the received digital program with a corresponding portion of at least one digital program stored in the memory device and determining, based on the comparison, whether the received digital program has previously been stored in the memory device. The received digital program is then selectively stored in the memory device, based on the determination as to whether the received digital program has previously been stored in the memory device.

A system is also disclosed including a receiving module to receive data relating to a digital program and a comparator module to access a memory device used for storing digital programs and to compare a portion of the received digital program with a corresponding portion of at least one digital program stored in the memory device. The system also includes a determining module to determine if the received digital program has previously been stored in the memory device. A storing module is to selectively store the received digital program, in the memory device, based on the determination of the determining module.

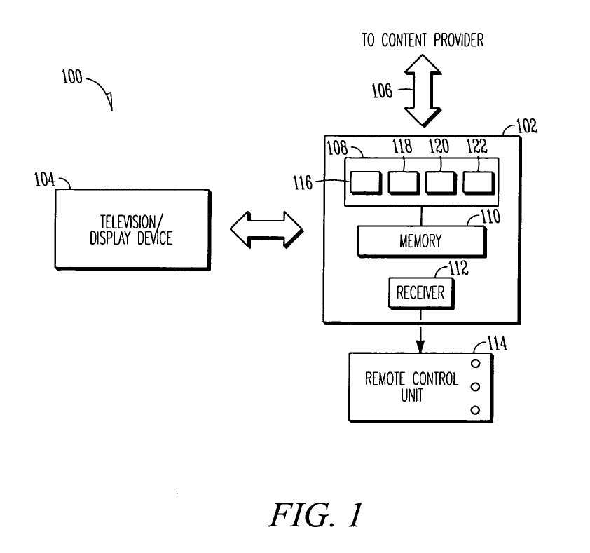

Referring to FIG. 1, a system is shown and is generally designated 100. As shown, the system 100 includes a digital video reorder (DVR) 102 that is coupled to a display device, such as a television 104. Additionally, the DVR 102 may form part of a set top box that is coupled to a content provider 106.

It will be appreciated that although the managing of a memory as described herein has been described in the context of a DVR, the method may find application in other deployment environments.

As shown in FIG. 1, the DVR 102 includes a processor 108 and a memory device 110 that is coupled to the processor 108. Further, a receiver 112 is coupled to the processor 108. A remote control unit 114 can communicate with the DVR 102 via the receiver 112. In a particular embodiment, the receiver can be an infrared (IR) receiver or a radio frequency (RF) receiver. A user can input one or more commands to the DVR 102 using the remote control unit 114.

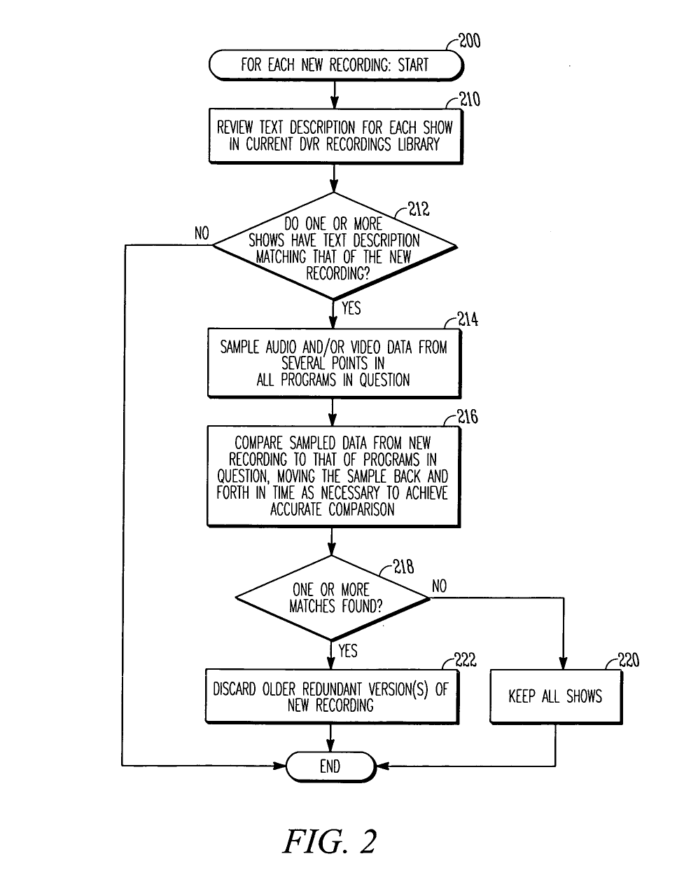

Referring to FIG. 2, one embodiment of a method of managing the memory of a DVR is shown. At block 200, for each new recording the process is started with the receiving of data relating to digital program. The memory device 110 used for storing digital programs is accessed and a text description for each program in the memory device 110 is reviewed, block 210.

The text description reviewed, in one example, is text metadata supplied in conjunction with the program or separately via an Electronic Program Guide (EPG) feed.

At decision block 212, it is determined whether one or more shows have a matching text description. In one embodiment, if there is no matching text then the process is ended and the DVR will record the new program (e.g., selectively store at the new program based on the absence of matching text).

However, if it is determined that one or more shows have a matching text description, then a portion of the received program is compared with a corresponding portion of at least one program stored in the memory device 110. This is carried out in block 214 and 216 where audio and or video data from several points in all programs in question are sampled and the sampled data from the new recording is compared to that of the programs in question, with the sample being moved back and forth in time as necessary to achieve an accurate comparison. This will be described in more detail below.

Continuing to decision step 218, it is determined, based on the comparison, if the received program has previously been stored in the memory device 110.

If not, then the received program is stored, block 220, in the memory device 110.

If yes, then in one example embodiment, the older version may be discarded and the newer version may be stored in the memory device 110, block 222. Accordingly, the newer version may be selectively stored, in an example embodiment, at block 222 based on a determination as to whether the receive program has previously been stored in the memory device 110 or not.

Alternative, the older version may be retained and the newer version is not recorded.

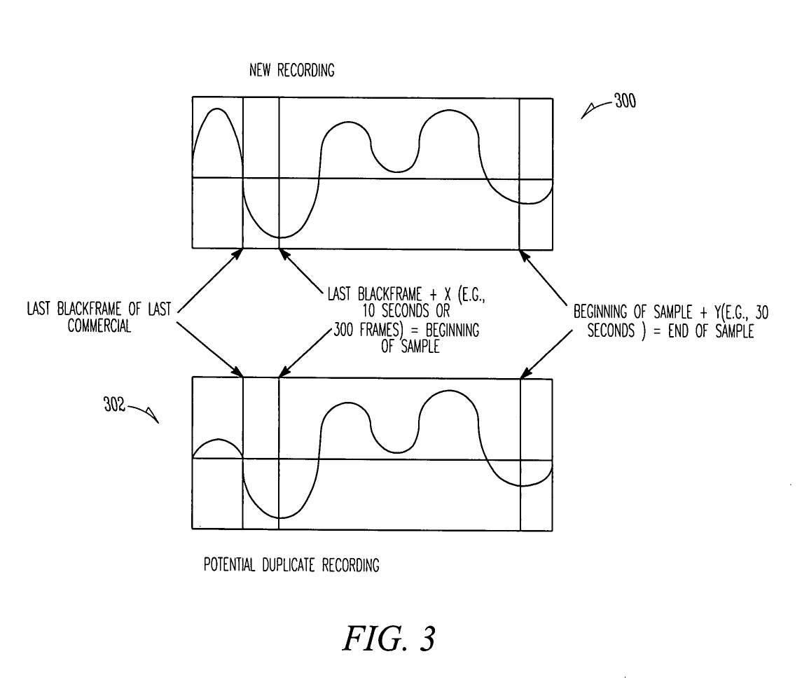

Referring to FIG. 3, an example method of comparing a portion of the received digital content (e.g., a program) with a corresponding portion of previously stored digital content (e.g., a program) is described in more detail.

In the illustrated example method, this is achieved by a waveform comparison.

Waveform sample data is taken from the new digital content 300 (e.g., newly received or a newly stored recordings or programs) and potential duplicate digital content 302 (e.g., previously stored recordings or programs). The sampled data may be video and/or audio data that constitutes digital content. An algorithm is used to attempt to secure like (or comparatively meaningful) data from both instances of content data (e.g., programs). For example, the algorithm may start its sample 10 seconds or 300 frames after the last blackframe at the end of the first commercial break is encountered, and stop its sample 30 seconds later.

It will be noted from the FIG. 3 that the waveform of the commercials may differ, though the program content is the same.

Samples may be taken from several points in the program to ensure program data is gathered instead of commercial data, which can be variable between the shows.

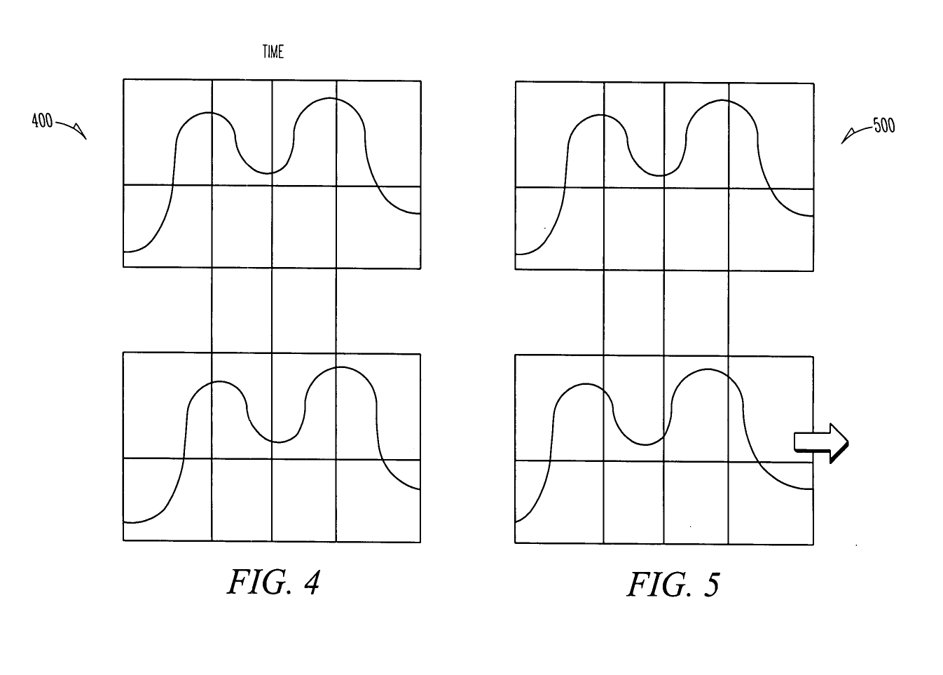

The sample data is compared, looking for sustained matching, for example over a certain period such as 30 seconds as shown at 400 in FIG. 4.

The waveform patterns may have to be shifted back and forth in time until the peaks and valleys are in alignment so an accurate comparison can be made, as shown at 500 in FIG. 5.

Thus the method specifies that when the DVR suspects, through comparison of text descriptions, that two episodes are the same, a comparison of audio and/or video waveform data is performed to determine if the two files are the same. If the files are the same, the older version is automatically deleted.

Accordingly, one embodiment seeks to ensure that every episode of a given show stored on the DVR is unique, maximizing the number of shows in the user's library.

In one example, the method is implemented in the system illustrated in FIG. 2. In an embodiment the processor 108 executes a receiving module 116 to receive data relating to a digital program. The processor 108 further executes a comparator module 118 to access the memory device 110 used for storing digital programs and to compare a portion of the received digital content (e.g., a digital program) with a corresponding portion of stored digital content (e.g., at least one digital program) stored in the memory device. Further the processor 108 executes a determining module 120 to determine if the received digital program has previously been stored in the memory device. Still further, the processor executes a storing module 122 wherein, if the received digital program has not previously been stored in the memory device then the storing module stores the received digital program in the memory device and if the received digital program has previously been stored in the memory device then the storing module deletes the previously stored program and stores the received digital program in the memory device.

It will be appreciated that the various modules described above may be executed by separate processors, and stored at various locations within a memory.

It will also be appreciated that the various modules described above in one embodiment may be implemented using software instructions stored on a machine-readable medium that, when executed by a machine, cause the machine to perform the methods described herein.

While the above example embodiment has been described within the context of a client side digital video recorder (DVR) (or personal video recorder (PVR)), a further embodiment may be implemented within the context of a network-based DVR or PVR.

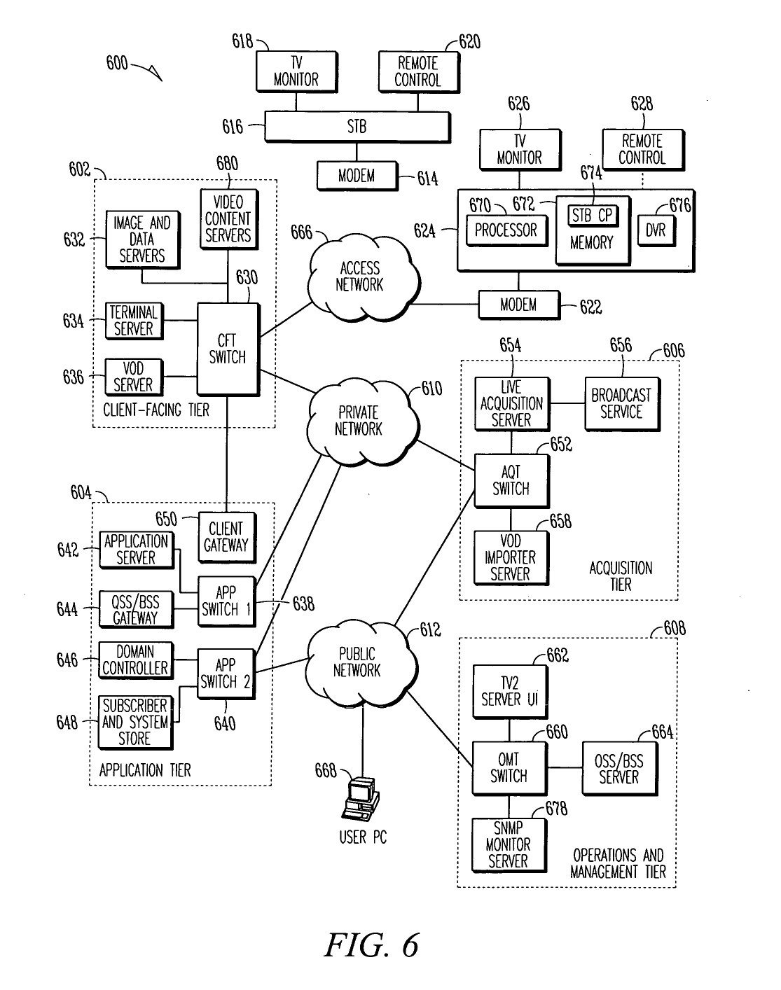

Further, an example embodiment may be implemented within the context of an Internet Protocol Television system, where the above described functionality is incorporated within a set-top box (STB) device. Referring to FIG. 6, an illustrative embodiment of an Internet Protocol Television (IPTV) system that may be used to provide video content is illustrated and is generally designated 600. As shown, the system 600 can include a client facing tier 602, an application tier 604, an acquisition tier 606, and an operations and management tier 608. Each tier 602, 604, 606, 608 is coupled to a private network 610; to a public network 612, such as the Internet; or to both the private network 610 and the public network 612. For example, the client-facing tier 602 can be coupled to the private network 610. Further, the application tier 604 can be coupled to the private network 610 and to the public network 612. The acquisition tier 606 can also be coupled to the private network 610 and to the public network 612. Additionally, the operations and management tier 608 can be coupled to the public network 612.

As illustrated in FIG. 6, the various tiers 602, 604, 606, 608 communicate with each other via the private network 610 and the public network 612. For instance, the client-facing tier 602 can communicate with the application tier 604 and the acquisition tier 606 via the private network 610. The application tier 604 can also communicate with the acquisition tier 606 via the private network 610. Further, the application tier 604 can communicate with the acquisition tier 606 and the operations and management tier 608 via the public network 612. Moreover, the acquisition tier 606 can communicate with the operations and management tier 608 via the public network 612. In a particular embodiment, elements of the application tier 604, including, but not limited to, a client gateway 650, can communicate directly with the client-facing tier 602.

As illustrated in FIG. 6, the client-facing tier 602 can communicate with user equipment via a private access network 666, such as an Internet Protocol Television (IPTV) access network. In an illustrative embodiment, modems, such as a first modem 614 and a second modem 622 can be coupled to the private access network 666. The client-facing tier 602 can communicate with a first representative set-top box device 616 via the first modem 614 and with a second representative set-top box device 624 via the second modem 622. The client-facing tier 602 can communicate with a large number of set-top boxes, such as the representative set-top boxes 616, 624, over a wide geographic area, such as a regional area, a metropolitan area, a viewing area, a designated market area or any other suitable geographic area, market area, or subscriber or customer group that can be supported by networking the client-facing tier 602 to numerous set-top box devices. In an illustrative embodiment, the client-facing tier, or any portion thereof, can be included at a video head-end office.

In a particular embodiment, the client-facing tier 602 can be coupled to the modems 614, 622 via fiber optic cables. Alternatively, the modems 614 and 622 can be digital subscriber line (DSL) modems that are coupled to one or more network nodes via twisted pairs, and the client-facing tier 6 can be coupled to the network nodes via fiber-optic cables. Each set-top box device 616, 624 can process data received via the private access network 666, via an IPTV software platform, such as Microsoft® TV IPTV Edition.

Additionally, the first set-top box device 616 can be coupled to a first external display device, such as a first television monitor 618, and the second set-top box device 624 can be coupled to a second external display device, such as a second television monitor 626. Moreover, the first set-top box device 616 can communicate with a first remote control 620, and the second set-top box device can communicate with a second remote control 628.

In an exemplary, non-limiting embodiment, each set-top box device 616, 624 can receive video content, which may include video and audio portions, from the client-facing tier 602 via the private access network 666. The set-top boxes 616, 624 can transmit the video content to an external display device, such as the television monitors 618, 626. Further, the set-top box devices 616, 624 can each include a STB processor, such as STB processor 670, and a STB memory device, such as STB memory 672, which is accessible to the STB processor 670. In one embodiment, a computer program, such as the STB computer program 674, can be embedded within the STB memory device 672. Each set-top box device 616, 624 can also include a video content storage module, such as a digital video recorder (DVR) 676. In a particular embodiment, the set-top box devices 616, 624 can communicate commands received from the remote control devices 620, 628 to the client-facing tier 602 via the private access network 666.

In an illustrative embodiment, the client-facing tier 602 can include a client-facing tier (CFT) switch 630 that manages communication between the client-facing tier 602 and the private access network 166 and between the client-facing tier 602 and the private network 610. As shown, the CFT switch 630 is coupled to one or more image and data servers 632 that store still images associated with programs of various IPTV channels. The image and data servers 632 can also store data related to various channels, e.g., types of data related to the channels and to programs or video content displayed via the channels. In an illustrative embodiment, the image and data servers 632 can be a cluster of servers, each of which can store still images, channel and program-related data, or any combination thereof. The CFT switch 630 can also be coupled to a terminal server 634 that provides terminal devices with a connection point to the private network 610. In a particular embodiment, the CFT switch 630 can also be coupled to a video-on-demand (VOD) server 636 that stores or provides VOD content imported by the IPTV system 600. The client-facing tier 602 can also include one or more video content servers 680 that transmit video content requested by viewers via their set-top boxes 616, 624. In an illustrative, non-limiting embodiment, the video content servers 180 can include one or more multicast servers.

As illustrated in FIG. 6, the application tier can communicate with both the private network 610 and the public network 612. The application tier 604 can include a first application tier (APP) switch 638 and a second APP switch 640. In a particular embodiment, the first APP switch 638 can be coupled to the second APP switch 640. The first APP switch 638 can be coupled to an application server 642 and to an OSS/BSS gateway 644. In a particular embodiment, the application server 642 can provide applications to the set-top box devices 616, 624 via the private access network 666, which enable the set-top box devices 616, 624 to provide functions, such as display, messaging, processing of IPTV data and VOD material, etc. In a particular embodiment, the OSS/BSS gateway 644 includes operation systems and support (OSS) data, as well as billing systems and support (BSS) data. In one embodiment, the OSS/BSS gateway can provide or restrict access to an OSS/BSS server 664 that stores operations and billing systems data.

Further, the second APP switch 640 can be coupled to a domain-controller 646 that provides web access, for example, to users via the public network 612. For example, the domain controller 646 can provide remote web access to IPTV account information via the public network 612, which users can access using their personal computers 668. The second APP switch 640 can be coupled to a subscriber and system store 648 that includes account information, such as account information that is associated with users who access the system 600 via the private network 610 or the public network 612. In a particular embodiment, the application tier 604 can also include a client gateway 650 that communicates data directly with the client-facing tier 602. In this embodiment, the client gateway 650 can be coupled directly to the CFT switch 630. The client gateway 650 can provide user access to the private network 610 and the tiers coupled thereto.

In a particular embodiment, the set-top box devices 616, 624 can access the IPTV system 600 via the private access network 666, using information received from the client gateway 650. In this embodiment, the private access network 666 can provide security for the private network 610. User devices can access the client gateway 650 via the private access network 666, and the client gateway 650 can allow such devices to access the private network 610 once the devices are authenticated or verified. Similarly, the client gateway 650 can prevent unauthorized devices, such as hacker computers or stolen set-top box devices from accessing the private network 610, by denying access to these devices beyond the private access network 666.

For example, when the first representative set-top box device 616 accesses the system 600 via the private access network 666, the client gateway 650 can verify subscriber information by communicating with the subscriber and system store 648 via the private network 610, the first APP switch 638, and the second APP switch 640. Further, the client gateway 650 can verify billing information and status by communicating with the OSS/BSS gateway 644 via the private network 610 and the first APP switch 638. In one embodiment, the OSS/BSS gateway 644 can transmit a query across the first APP switch 638, to the second APP switch 640, and the second APP switch 640 can communicate the query across the public network 612 to the OSS/BSS server 664. After the client gateway 650 confirms subscriber and/or billing information, the client gateway 650 can allow the set-top box device 616 access to IPTV content and VOD content. If the client gateway 650 cannot verify subscriber information for the set-top box device 616, e.g., because it is connected to an unauthorized twisted pair, the client gateway 650 can block transmissions to and from the set-top box device 616 beyond the private access network 666.

As indicated in FIG. 6, the acquisition tier 606 includes an acquisition tier (AQT) switch 652 that communicates with the private network 610. The AQT switch 652 can also communicate with the operations and management tier 608 via the public network 612. In a particular embodiment, the AQT switch 652 can be coupled to a live acquisition server 654 that receives television or movie content, for example, from a broadcast service 656. In a particular embodiment during operation of the IPTV system, the live acquisition server 654 can acquire television or movie content. The live acquisition server 654 can transmit the television or movie content to the AQT switch 652, and the AQT switch 652 can transmit the television or movie content to the CFT switch 630 via the private network 610.

Further, the television or movie content can be transmitted to the video content servers 180, where it can be encoded, formatted, stored, or otherwise manipulated and prepared for communication to the set-top box devices 616, 624. The CFT switch 630 can communicate the television or movie content to the modems 614, 622 via the private access network 666. The set-top box devices 616, 624 can receive the television or movie content via the modems 614, 622, and can transmit the television or movie content to the television monitors 618, 626. In an illustrative embodiment, video or audio portions of the television or movie content can be streamed to the set-top box devices 616, 124.

Further, the AQT switch can be coupled to a video-on-demand importer server 658 that stores television or movie content received at the acquisition tier 606 and communicates the stored content to the VOD server 636 at the client-facing tier 602 via the private network 610. Additionally, at the acquisition tier 606, the video-on-demand (VOD) importer server 658 can receive content from one or more VOD sources outside the IPTV system 600, such as movie studios and programmers of non-live content. The VOD importer server 658 can transmit the VOD content to the AQT switch 652, and the AQT switch 652, in turn, can communicate the material to the CFT switch 630 via the private network 610. The VOD content can be stored at one or more servers, such as the VOD server 636.

When user issue requests for VOD content via the set-top box devices 616, 624, the requests can be transmitted over the private access network 666 to the VOD server 636, via the CFT switch 630. Upon receiving such requests, the VOD server 636 can retrieve the requested VOD content and transmit the content to the set-top box devices 6166 across the private access network 166, via the CFT switch 630. The set-top box devices 616, 624 can transmit the VOD content to the television monitors 618, 626. In an illustrative embodiment, video or audio portions of VOD content can be streamed to the set-top box devices 616, 624.

FIG. 6 further illustrates that the operations and management tier 608 can include an operations and management tier (OMT) switch 660 that conducts communication between the operations and management tier 608 and the public network 612. In the embodiment illustrated by FIG. 1, the OMT switch 660 is coupled to a TV2 server 662. Additionally, the OMT switch 660 can be coupled to an OSS/BSS server 664 and to a simple network management protocol (SNMP) monitor 678 that monitors network devices within or coupled to the IPTV system 600. In a particular embodiment, the OMT switch 660 can communicate with the AQT switch 652 via the public network 612.

In an illustrative embodiment, the live acquisition server 654 can transmit the television or movie content to the AQT switch 652, and the AQT switch 652, in turn, can transmit the television or movie content to the OMT switch 660 via the public network 612. In this embodiment, the OMT switch 160 can transmit the television or movie content to the TV2 server 662 for display to users accessing the user interface at the TV2 server 662. For example, a user can access the TV2 server 662 using a personal computer (PC) 668 coupled to the public network 612.

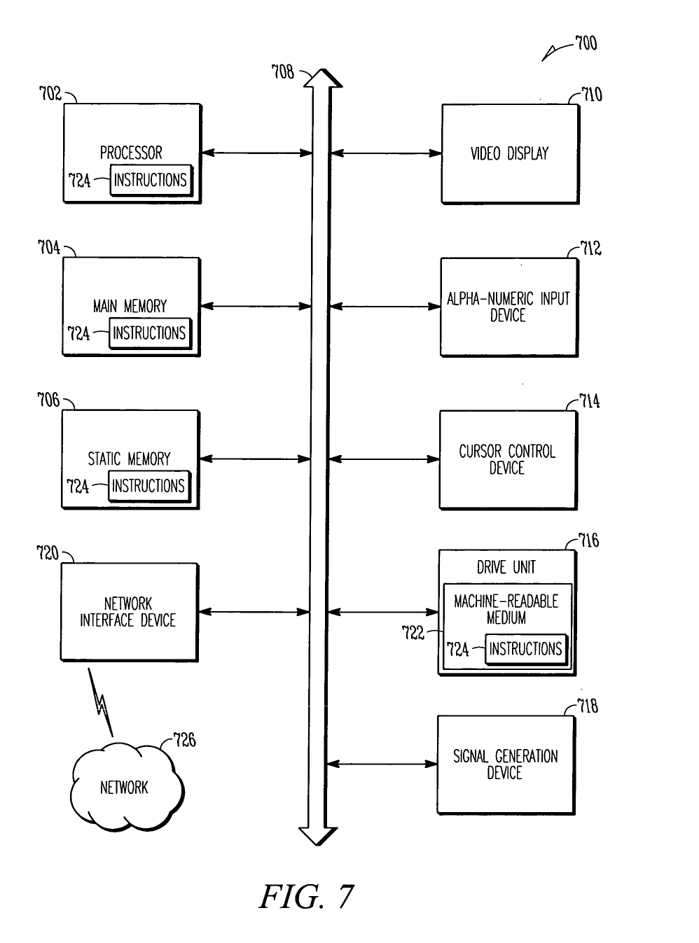

FIG. 7 shows a diagrammatic representation of machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a digital video recorder (DVR), a personal video recorder (PVR), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720 utilizing any one of a number of well-known transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method including:
receiving digital content;
accessing a memory device used for storing digital content;
comparing a portion of the received digital content with a corresponding portion of previously stored digital content stored in the memory device; and
determining, based on the comparison, whether the received digital content has previously been stored in the memory device; and
selectively storing the received digital content in the memory device, based on the determination.

2. The method of claim 1 wherein the selective storing includes storing the received digital content in the memory device, based on a determination that the received digital content has not previously been stored in the memory device.

3. The method of claim 1 wherein the selective storing includes deleting the previously stored digital content and storing the received digital content in the memory device, based on a determination that the received digital content has previously been stored in the memory device.

4. The method of claim 1 including comparing a plurality of portions of the received digital content with a corresponding plurality of portions of the previously stored digital content.

5. The method of claim 1 including:
comparing text metadata of the received digital content with text metadata of the previously stored digital content stored in the memory device before comparing the portion of the received digital content with the corresponding portion of the previously stored digital content stored in the memory device; and
determining if the received digital content has previously been stored in the memory device based on the comparison of the text metadata.

6. The method of claim 1 wherein the comparing of the portion of the received digital content with the corresponding portion of the previously stored digital content stored in the memory device is performed by comparing a waveform of the received digital content with a corresponding waveform of the previously stored digital content.

7. The method of claim 1, wherein the received digital content includes at least one of digital audio data and digital video data.

8. A system including:
a receiving module to receive a digital content;
a comparator module to access a memory device used for storing digital content and to compare the received digital content with previously stored digital content stored in the memory device;
a determining module to determine whether the received digital content corresponds to the previously stored digital content; and
a storing module selectively to store the received digital content in the memory device based on a determination of the determining module.

9. The system of claim 8 further wherein the storing module is to store the received digital content in the memory device, based on a first determination by the determining module that the received digital content does not correspond to the previously stored digital content.

10. The system of claim 8 wherein the storing module is to delete the previously stored digital content and to store the received digital content in the memory device, based on a second determination by the determining module that the received digital content does correspond to the previously stored digital content.

11. The system of claim 8 wherein the comparator module is to compare a plurality of portions of the received digital content with a corresponding plurality of portions of the previously stored digital content.

12. The system of claim 8 wherein:
the comparator module is to compare text metadata of the received digital content with text metadata of the previously stored digital content before comparing the received digital content with the previously stored digital content stored in the memory device; and
the determining module is to determine if the received digital content corresponds to the previously stored digital content based on the comparison of the text metadata.

13. The system of claim 8 wherein the comparator module is to compare a portion of the received digital content with a corresponding portion of the previously stored digital content stored in the memory device by comparing a waveform of the received digital content with a corresponding waveform of the previously stored digital content stored in the memory device.

14. A system including:
receiving means for receiving a digital content;
comparator means for accessing a memory device used for storing digital content and for comparing a portion of the received digital content with a corresponding portion of previously stored digital content stored in the memory device;
determining means for determining if the received digital content has previously been stored in the memory device, based on the comparison performed by the comparator means; and
storing means for selectively storing the received digital content into the memory device, based on a determination of the determining means.

15. The system of claim 14 wherein the storing means is for storing the received digital content in the memory device, based on a first determination of the determining means that the received digital content has not previously been stored in the memory device.

16. The system of claim 15 wherein the storing means is for deleting the previously stored content from the memory device and for storing the received digital content in the memory device, based on a second determination of the determining means that the received digital content has previously been stored in the memory device.

17. The system of claim 14 wherein the comparator means is for comparing a plurality of portions of the received digital content with a corresponding plurality of portions of the previously stored digital content stored in the memory device.

18. The system of claim 14 wherein:
the comparator means is for comparing first text metadata of the received digital content with second text metadata of the previously stored digital content stored in the memory device, before comparing a corresponding portion of the received digital content with the previously stored digital content stored in the memory device; and
the determining means is for determining if the received digital content has previously been stored in the memory device based on the comparison of the first and second text metadata.

19. The system of claim 14 wherein the comparator means is for comparing a portion of the received digital content with a corresponding portion of the previously stored digital content stored in the memory device by comparing a first waveform of the received digital content with a second waveform of the previously stored digital content stored in the memory device.

20. A machine-readable medium having instructions that, when executed by a machine, cause the machine to perform a method including:
receiving digital content;
accessing a memory device used for storing digital content;
comparing a portion of the received digital content with a corresponding portion of previously stored digital content stored in the memory device;
determining, based on the comparison, that the received digital content corresponds to the previously stored digital content; and
selectively storing the received digital content in the memory device, based on the determination.
